(19) United States
(12) Patent Application Publication
(10) Pub. No.: US 2025/0083066 A1
(43) Pub. Date: Mar. 13, 2025

(54) HEATING AND DEPOSITION FOR BENEFICIATION OF LUNAR REGOLITH

(71) Applicant: Blue Origin, LLC, Kent, WA (US)

(72) Inventors: Alexander lmbault, Sierra Madre, CA (US); Jonathan Grandidier, Pasadena, CA (US); Erica Mae Pitcavage, Altadena, CA (US); Jesse Dylan Tarnas, Los Angeles, CA (US)

(21) Appl. No.: 18/464,849

(22) Filed: Sep. 11, 2023

(51) Int. Cl. B01D 7/00; C03C 3/06; H01L 31/048

(52) U.S. Cl. CPC B01D 7/00; C03C 3/06; H10F 19/80; C03C 2201/02; C03C 2203/52

(57) ABSTRACT

Methods and configurations for solar heating and beneficiation of a material, such as raw mine-extracted material like lunar rocks or regolith, are presented. Beneficiation may have an end-goal of purifying the material and/or removing particular impurities or undesired substances from the material. For example, purification or elimination of particular substances from a bulk material may be achieved by vaporizing, via solar or electron beam heating, a portion of the bulk material that does not include the particular substances. The bulk material, sans the particular substances, may be subsequently condensed onto a cold substrate as a thin film, which itself may be placed in a subsequent beneficiation iteration for further elimination of selected substances.

### BACKGROUND

Fabrication of devices and processing of materials are generally energy-intensive operations. Most often, this energy takes the form of electricity. On Earth, there is an ever-increasing recognition that energy is a valuable resource to be conserved or used wisely. On the Moon, availability of energy, such as electricity for use in fabrication or material processing, is presently limited to Earth-derived resources (e.g., fuel cells, batteries, etc.). Thus, providing electricity for fabrication or material processing on the Moon may be challenging.

Lunar regolith is composed of a mixture of rocks and minerals, the fundamental chemical components of which are elements typically expressed as oxides, including silica, titania, alumina, magnesia, iron oxide, and calcium oxide. For most applications it is beneficial to have some oxides and less of others. Some elements and their oxides may be detrimental if included in material to make clear glass, which may be used in the fabrication of solar cells for providing electricity on the Moon. For example, the presence of iron oxide in materials used for glass fabrication may result in relatively dark, low-transmittance glass. In addition to possible problems created by the presence of undesired components in a bulk material, impurities in the bulk material not only can modify the development of grain structure formation but can also interact with structural defects to create regions of deleterious minority carrier lifetime recombination in solar cells, for example.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic view of concentrated sunlight incident on a mass of material leading to evaporation and condensation into a thin film, according to some embodiments.

FIG. 2 is a schematic view of a spot of concentrated sunlight incident on a thin film leading to evaporation and condensation into a second thin film, according to some embodiments.

FIG. 3 is a schematic representation of an iterative beneficiation process, according to some embodiments.

FIG. 4 is a schematic view of a spot of concentrated sunlight incident on a thin film, according to some embodiments.

FIG. 5 illustrates various example embodiments of spots of concentrated sunlight.

FIG. 6 is a schematic view of a spot of concentrated sunlight varying in location on a surface of material, according to some embodiments.

FIG. 7 is a schematic cross-section view of an optical assembly that includes moveable optical elements, according to some embodiments.

FIG. 8 is a flow diagram of a process for solar heated beneficiation of a material, according to some embodiments.

### DETAILED DESCRIPTION

This disclosure describes methods and configurations for solar heating and beneficiation of a material, such as raw geologic material like lunar rocks or regolith. Other methods for heating, instead of, or in addition to, solar heating may include electron-beam (e-beam) heating, for example. Beneficiation may have an end-goal of purifying or increasing the concentration of a material and/or removing particular impurities or undesired substances from the material. For example, in some implementations, beneficiation may be used to yield an iron-free material (e.g., purified quartz) from a material that previously included iron oxide. The iron oxide-free material may be glass that can be deposited as a thin film on a substrate, for example. The use of solar heating allows these processes to occur without electricity, which may be a scarce resource on the Moon.

Lunar regolith, rocks, or other impure feedstocks may generally lead to materials with impurities that are undesired in subsequent steps of production or fabrication. For example, silicon needs to be purified (e.g., greater than 99.999% pure) before being utilized for solar panels.

Techniques for solar heating, described herein, may be applied to beneficiation processes of various materials. For example, elimination of particular substances from a bulk material may be achieved by vaporizing, via solar heating, a portion of the bulk material that does not include the particular substances. This may be accomplished by heating the bulk material to temperatures beyond the boiling points of desired substances in the bulk material while maintaining the temperature below the boiling points of the undesired particular substances. The bulk material, sans the particular substances, may be subsequently condensed onto a cold substrate as a thin film, as described below. For example, silicon may be deposited, via condensation, as thin film layers (e.g., with thicknesses of hundreds of nanometers) using concentrated sunlight to evaporate or sublimate the silicon in a bulk, raw material that includes impurities or undesired substances such as iron oxide. In a particular embodiment, silicon may be in a quartz crucible while concentrated sunlight is focused on the silicon. The concentrated sunlight heats the silicon to its boiling temperature. Above its boiling temperature, the silicon evaporates and subsequently deposits onto a relatively cold substrate. Such a deposition process may allow for glass-covered solar cell fabrication using concentrated sunlight. The use of sunlight for heating can replace the use of electricity, which would otherwise power a deposition process using an electron beam or thermal evaporation resulting from consuming tens to hundreds of kilowatts (e.g., 208 VAC, 3-Ph). In other implementations, however, electron beam heating may be used for performing the beneficiation processes described herein, and claimed subject matter is not limited to any particular method of heating.

In some embodiments, a method for solar heated beneficiation of a material may include providing, via an optical assembly, a spot of concentrated sunlight onto the material to vaporize at least a portion of the material. The optical assembly may be configured to collect sunlight and condense the sunlight to a focused, concentrated spot that may impinge on the material. The material may be crushed regolith or other raw material, for example. The optical assembly may include optical elements, such as lenses and/or mirrors, that are moveable to vary the location of the focused spot of sunlight on the material. In some implementations, an optical assembly may be a parabolic solar reflector that is configured to track the movement of the sun across the sky (e.g., via stepper motors, etc.). A parabolic solar reflector may produce a focused beam of light that may be aimed onto a material for heating the material. The spot of concentrated sunlight may heat and vaporize the material, which may be collected via condensation on a relatively cold substrate. Thus, the condensed material may form a thin film. The vaporized material may be exposed to the vacuum of the Moon while transiting to the substrate. This exposure, of the substrate and the vaporized material, may help prevent impurities from adding into the condensing thin film by facilitating a degree of purification based on vapor pressure differences.

The method for solar heated beneficiation may further include, as mentioned above, collecting at least a portion of the vaporized material on a first substrate to form a first thin film. Subsequently, a second spot of concentrated sunlight may be aimed onto the first thin film to vaporize at least a portion of the first thin film. At least a portion of the vaporized first thin film may be collected on a second substrate to form a second thin film. At this stage, solar heated beneficiation may be complete, depending on whether the second thin film is the desired material or has desired physical properties. In other words, the method for solar heated beneficiation may be complete at this stage or may continue with another iteration of vaporizing the second thin film to form a third thin film, and so on until the resulting thin film is the desired material or has desired physical properties.

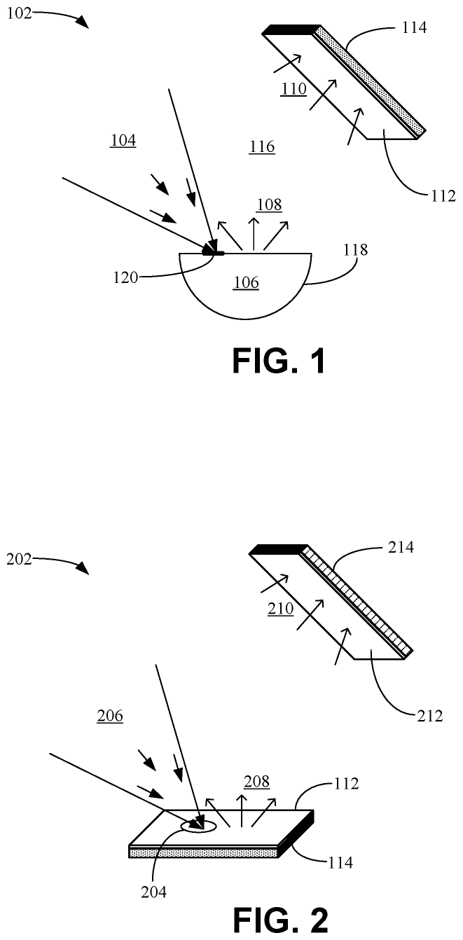

FIG. 1 is a schematic view of a configuration 102 that includes concentrated sunlight 104 incident on a mass of material 106 leading to evaporation, indicated by arrows 108, and condensation, indicated by arrows 110, into a thin film 112, according to some embodiments. Thin film 112 may form on a substrate 114 that is relatively cold to allow for condensation of the ambient vapor from material 106. In some implementations, the environment 116 of the Moon may be used to maintain the cold substrate temperatures. Herein, a substrate being relatively cold means that the substrate is substantially colder than an ambient vaporized material. One substrate is illustrated for clarity, but multiple substrates may be included in configuration 102 to capture vaporized material. The direction and orientation of concentrated sunlight 104 and material 106, as well as the container 118 holding the material, are merely examples and claimed subject matter is not so limited. Though examples of processes of beneficiation described herein are performed on the Moon with lunar regolith, such processes may also be performed on Earth with earth-sourced materials, and claimed subject matter is not limited in this respect.

Concentrated sunlight 104 impinges as a spot 120 on material 106. As explained below, the shape and size of the spot, and its location on material 106, may be varied to allow for uniform heating of the material surface.

In a process of beneficiation, as described above, concentrated sunlight 104 heats material 106 leading to evaporation and condensation into formation of thin film 112 on substrate 114. The portion of material 106 that is evaporated may be controlled by controlling the temperature of the material. For example, an impurity in material 106 that has a boiling temperature above the boiling temperature of material 106 may be excluded (e.g., left behind) from vaporization of material 106 by maintaining the temperature of material 106 between the two boiling temperatures. Thus, a condensed thin film (e.g., 112) will not include the impurity. The temperature of material 106 may be controlled by controlling (e.g., via a shutter or other control of concentrated sunlight) the amount of time that material 106 is exposed to concentrated sunlight 104, the flux and/or the intensity of the concentrated sunlight.

FIG. 2 is a schematic view of a configuration 202 that includes substrate 114 with thin film 112 exposed to a spot 204 of concentrated sunlight 206, which may lead to evaporation, represented by arrows 208, of a portion of thin film 112 and condensation, represented by arrows 210, into a second thin film 212 on a substrate 214, according to some embodiments. The direction and orientation of concentrated sunlight 206 and thin film 112, as well as its size and shape, are merely examples, and claimed subject matter is not so limited.

Configuration 202 is an arrangement of substrates allowing for evaporating a portion of a thin film, which was previously formed by evaporation/condensation in a previous step, illustrated in FIG. 1, into a second thin film. A process of beneficiation may generally involve iterative steps of evaporation/condensation that each produce a thin film that is closer than that of the previous iterative step to a material having the desired properties and/or composition. For example, though thin film 112 may have less impurities than that of material 106, there may remain a need for another evaporation/condensation step, provided by configuration 202, that can remove additional impurities from thin film 112. Resultantly, there may be fewer impurities in thin film 212 than in thin film 112. In some implementations, thin film 212 may be subjected to another evaporation/condensation iteration to further remove impurities. Such an iterative process of beneficiation is described below.

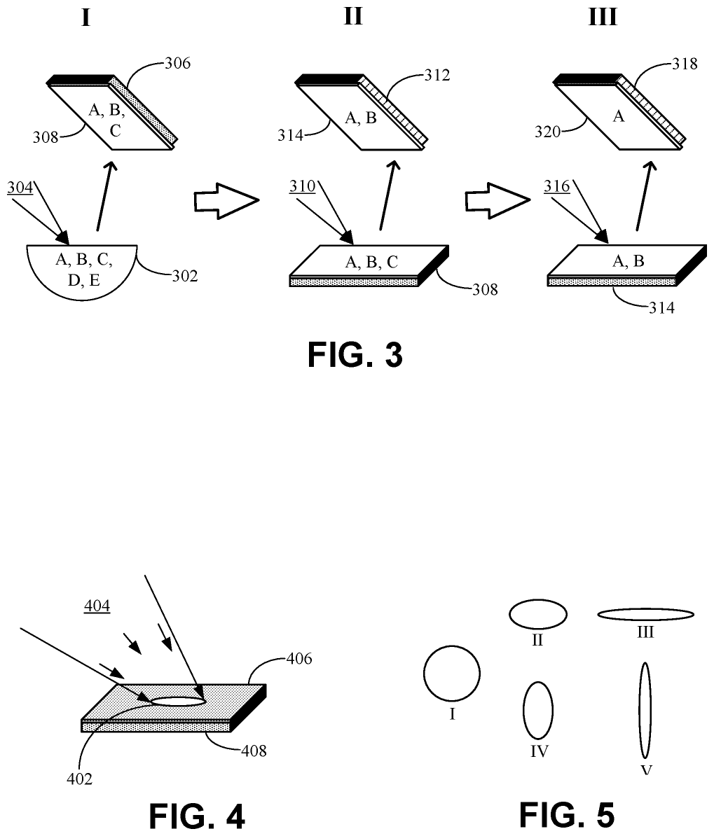

FIG. 3 is a schematic representation of an iterative beneficiation process, according to some embodiments. Generally, a single beneficiation process may not yield a desired material, but merely provide an intermediate material for one or more subsequent beneficiation processes that ultimately end with the desired material. For example, a bulk material comprising substances A, B, C, D, and E in a container 302 may be heated by concentrated sunlight 304. Generally, different substances will evaporate at different temperatures, which may be respective boiling temperatures. Concentrated sunlight 304 heats the bulk material of beneficiation process I to a temperature above boiling points of substances A, B, and C, but below boiling points of substances D and E. Thus, substances A, B, and C evaporate and condense onto a cold substrate 306 to form a thin film 308 comprising only these substances as a result of substances D and E being left behind in container 302. In some implementations, thin film 308 comprising substances A, B, and C may be the desired material and there need not be any additional beneficiation iterations. In other implementations, thin film 308 is only an intermediate material because, for example, substance C is an undesired substance in thin film 308. Accordingly, beneficiation process II may be performed with concentrated sunlight 310 heating thin film 308 to a temperature above boiling points of substances A and B but below the boiling point of substance C. Thus, substances A and B evaporate and condense onto a cold substrate 312 to form a thin film 314 comprising only these substances as a result of substance C being left behind in thin film 308. In some implementations, thin film 314 comprising substances A and B may be the desired material and there need not be any additional beneficiation iterations. In other implementations, thin film 314 is only yet another intermediate material because, for example, substance B is an undesired substance in thin film 314. In these implementations, the desired material may be only substance A sans any impurities.

Accordingly, beneficiation process III may be performed with concentrated sunlight 316 heating thin film 314 to a temperature above the boiling point of substance A but below the boiling point of substance B. Thus, substance A evaporates and condenses onto a cold substrate 318 to form a thin film 320 comprising only substantially purified substance A as a result of substance B being left behind in thin film 314.

FIG. 4 is a schematic view of a spot 402 of concentrated sunlight 404 incident on a mass of material 406, which may be a thin film on a substrate 408 or bulk material in a container (e.g., 118), according to some embodiments. This situation may be similar to or the same as those illustrated in FIGS. 1-3, for example. Heat from spot 402 principally heats the material in the spot. Diffusion of heat from the material in the spot may also heat surrounding material. The rate and extent to which diffusion heats the surrounding material may depend on the material, spot size, and the intensity of concentrated sunlight 404, among other things. As described below, in some implementations, processes of melting, boiling, or evaporating material may involve varying the location, size, and or shape of spot 402 on the mass of material. For example, such variations may allow for increasing uniformity of heating of the mass of material. Such variations in spot size may also allow for changing the intensity of the concentrated sunlight. For the same quantity of incoming sunlight, a smaller spot size will provide heat that is more intense than that of a larger spot. Accordingly, varying the spot size may allow for controlling the rate of melting or vaporizing a material.

FIG. 5 illustrates various example embodiments of spots of concentrated sunlight, which may represent the example spots illustrated in FIGS. 1-4. The various sizes and shapes of spots I-V may be formed by a series of lenses and/or mirrors placed between a material surface and the incoming sun rays. Shapes of the spots may be formed by spheric or aspheric lenses or mirrors or gradient-index lenses, for example.

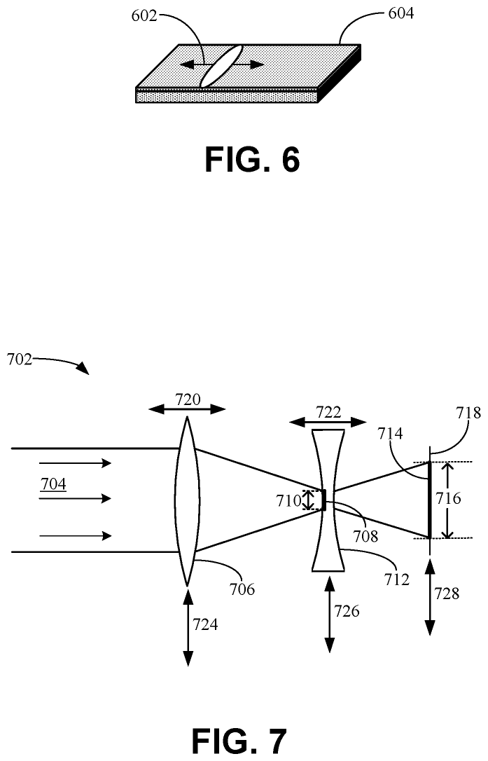

In addition to the circular and elliptical shapes, a concentrated sunlight spot may be substantially square or rectangular. Also, in addition to varying shapes, a process of heating a material may involve moving, from time to time or cyclically, the spot across the surface of the material. This is illustrated in FIG. 6. For example, the elongated spot III or V may be cyclically moved, represented by arrows 602, across a surface area of material 604 so that substantially all portions of the area are equally and uniformly heated.

FIG. 7 is a schematic cross-section view of an optical assembly 702 that includes moveable optical elements, according to some embodiments. Such optical elements may be mirrors and or lenses. Though lenses are illustrated in the figure, some or all of the lenses may be replaced by mirrors. For example, spherical or aspherical mirrors may provide focus and collimation similar to or the same as corresponding lenses. Thus, claimed subject matter is not limited to lenses or mirrors in an optical assembly.

In the example illustrated in the figure, sunlight 704 is incident on a first optical element 706, which may be a convex lens. Sunlight 704 may be naturally collimated due to the large distance to the sun or may be a priori focused by one or more beam steering elements not illustrated. For example, such beam steering may arise from tracking the sun's movement across the sky. In some implementations, however, optical assembly 702, or a portion thereof, may be rotated to track the movement of the sun's position. First optical element 706 may focus and concentrate sunlight 704 to a spot 708 having a spot size 710. Spot 708 may be incident on a material for heating the material. In this case, optical assembly 702, as described thus far, is relatively simple, comprising a “single” lens (e.g., not to exclude the possible use of a compound lens) or mirror. Spot size 710 may be varied by changing the distance between the surface of the material and first optical element 706.

The addition of another lens (or mirror), however, may allow for techniques for varying the size and location of the concentrated sunlight spot without moving the material to be heated. For example, the addition of second optical element 712, which may be a concave lens, may produce a spot 714 having a size 716 larger than that of spot 708 (depending on the distance between the surface of the material and first optical element 706) on a material surface 718. Generally, the size of the spot depends on the relative distances between first and second optical elements and material surface 718. Accordingly, the relative locations of the optical elements may be moved, represented in the figure by arrows 720 and 722, respectively, to vary the size of the spot (e.g., 708 or 714).

In addition to changing their relative distances apart, the optical elements may be moved transversely off axis, as represented in the figure by arrows 724 and 726, to vary the location of the concentrated sunlight spot on the surface of the material. For example, movement of second optical element in a direction 726 may lead to spot 714 changing location, indicated by arrow 728, on material surface 718.

In some embodiments, though not illustrated, optical assembly 702 may include an optical shutter that may be used to regulate the amount of concentrated sunlight (e.g., heat) incident on a material to be heated. For example, such an optical shutter may open and close cyclically or from time-to-time, wherein a closed shutter blocks incident sunlight and an opened shutter allows incident sunlight to impinge on the material. The shutter may be opened and closed via one or more motion transducers, similar to or the same as what may be used to move any of the optical elements in optical assembly 702.

Generally, electromagnetic energy in the ultraviolet (UV) through the infrared (IR) spectrum is transmitted, reflected, and/or absorbed by optical elements. Energy that is absorbed by an optical element contributes to heating the optical element. Because optical elements included in optical assembly 702 are receiving sunlight, and because some of the elements are receiving at least partially concentrated, high-intensity sunlight, even a relatively small percentage of absorption may detrimentally affect these optical elements due to relatively high heat input. Accordingly, in some embodiments, the relatively cold environment in shadowed areas of the Moon may be used to maintain relatively cool temperatures of the optical elements. For example, while portions of the optical elements in the optical path of the sunlight may heat due to absorption, cold portions of the optical elements outside the optical path (e.g., edge portions of the optical elements) where sunlight is blocked (e.g., shadowed areas) may draw the heat away from the optical path portions of the elements. In some implementations, radiative heat sinks may be attached to optical elements outside the optical path.

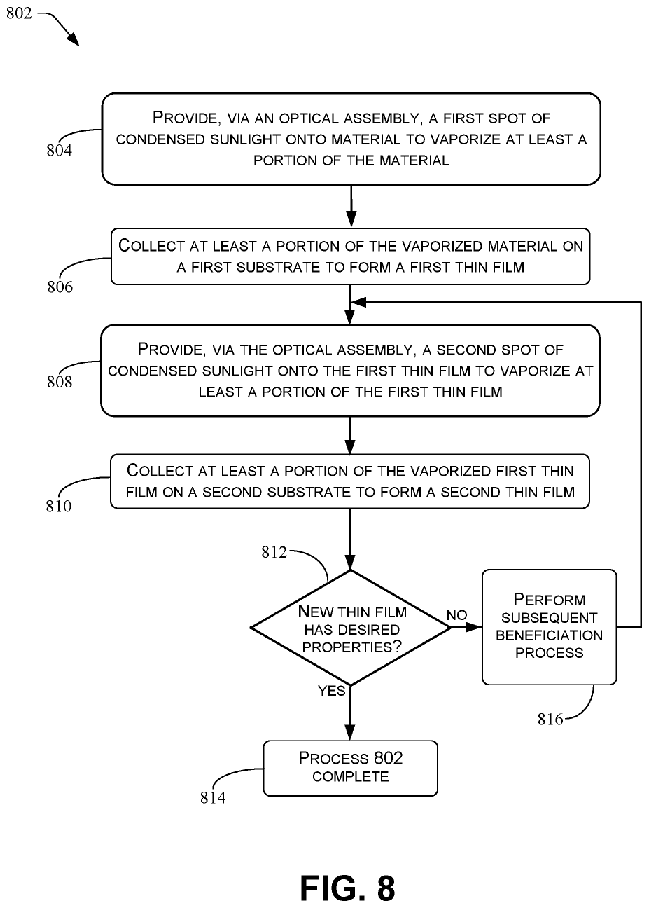

FIG. 8 is a flow diagram of a process 802 for solar heated beneficiation of a material, according to some embodiments. Process 802 may be performed by an operator that is human, a computer processor performing executable electronic instructions, or a combination of both. For sake of example, process 802 is described below as being applied to configurations 102 and 202.

At 804, an operator may provide, via an optical assembly (e.g., 702), a first spot 120 of concentrated sunlight 104 onto material 106 to vaporize (e.g., 108) at least a portion of the material. At 806, the operator may collect at least a portion of the vaporized material on a first substrate 114 by allowing a first thin film 112 to form (e.g., via condensation) on the substrate. At 808, the operator may provide, via the optical assembly, a second spot 204 of concentrated sunlight 206 onto first thin film 112 to vaporize (e.g., 208) at least a portion of the first thin film. At 810, the operator may collect at least a portion of the vaporized first thin film on a second substrate 214 by allowing a second thin film 212 to form on the substrate.

In some embodiments, process 802 may allow for glass-covered solar cell fabrication using concentrated sunlight. For example, second substrate 214 may be a photovoltaic cell and second thin film 212 may be transparent glass that covers, as a thin film layer, the photovoltaic cell. In this example, material 106 may be lunar regolith containing iron oxide, the presence in silica of which is generally responsible for relatively dark glass. The boiling point of iron oxide may be substantially above that of most of the other substances in lunar regolith. If so, then first thin film 112, which is material evaporated from 106, may have substantially less iron oxide than material 106. The additional process of vaporizing at least a portion of the first thin film and forming a second thin film 212 may be to remove other substances from the first thin film and/or to form substantially purified transparent silicate glass on substrate 214.

At 812, the operator may determine whether to vaporize the second thin film to form a third thin film, the determining based on physical properties of the second thin film. If second thin film 212 has desired physical properties, such as desired chemical composition, or desired purity, for example, then process 802 may proceed to 814 where the process is complete as a result of the second thin film being the desired final material. On the other hand, if second thin film 212 is not the desired final material, or does not have the desired physical properties, then process 802 may proceed to 816 to perform a subsequent beneficiation process by returning to 808 for another iteration of the beneficiation process.

In some implementations, the operator may use the environment of the Moon to maintain first substrate and second substrate temperatures that are substantially colder than the vaporized material and the vaporized first thin film. The operator may also expose the vaporized material and the vaporized first thin film to the vacuum of the Moon. The operator may vary relative positions of optical elements of the optical assembly to vary the location of the spot of concentrated sunlight on the material.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method for solar heated beneficiation of a material, the method comprising:
providing, via an optical assembly, a first spot of concentrated sunlight onto the material to vaporize at least a portion of the material;
collecting at least a portion of the vaporized material on a first substrate to form a first thin film;
providing, via the optical assembly, a second spot of concentrated sunlight onto the first thin film to vaporize at least a portion of the first thin film;
collecting at least a portion of the vaporized first thin film on a second substrate to form a second thin film; and
determining whether to vaporize the second thin film to form a third thin film, the determining based on physical properties of the second thin film.

2. The method of claim 1, wherein the second substrate comprises a photovoltaic cell and the second thin film comprises transparent glass.

3. The method of claim 1, wherein the concentration of iron oxide in the first thin film is less than the concentration of iron oxide in the material.

4. The method of claim 1, wherein the concentration of impurities in the first thin film is less than the concentration of the impurities in the material.

5. The method of claim 4, wherein the concentration of impurities in the second thin film is less than the concentration of the impurities in the first thin film.

6. The method of claim 4, wherein the impurities originate from lunar regolith.

7. The method of claim 1, wherein the material comprises lunar regolith.

8. The method of claim 1, wherein the physical properties of the second thin film include chemical composition of the second thin film.

9. The method of claim 1, wherein the physical properties of the second thin film include concentration of impurities in the second thin film.

10. The method of claim 1, further comprising using the environment of the Moon to maintain first substrate and second substrate temperatures that are substantially colder than the vaporized material and the vaporized first thin film, respectively.

11. The method of claim 1, further comprising varying relative positions of optical elements of the optical assembly to vary the location of the spot of concentrated sunlight on the material.

12. The method of claim 1, further comprising exposing the vaporized material and the vaporized first thin film to the vacuum of the Moon.

13. The method of claim 1, wherein the second thin film comprises glass.

14. A method for solar heated beneficiation of a material, the method comprising:
providing concentrated sunlight onto the material to vaporize at least a portion of the material;
condensing at least a portion of the vaporized material on an intermediary surface to form a first thin film on the intermediary surface;
providing concentrated sunlight onto the first thin film to vaporize at least a portion of the first thin film;
condensing at least a portion of the vaporized first thin film on a substrate to form a second thin film; and
determining whether to vaporize the second thin film to form a third thin film, the determining based on chemical composition of the second thin film.

15. The method of claim 14, wherein the substrate comprises a photovoltaic cell and the second thin film comprises transparent glass.

16. The method of claim 14, wherein the concentration of iron oxide in the first thin film is less than the concentration of iron oxide in the material.

17. The method of claim 14, wherein the concentration of impurities in the first thin film is less than the concentration of the impurities in the material.

18. The method of claim 17, wherein the impurities originate from lunar regolith.

19. The method of claim 14, wherein the material comprises lunar regolith.

20. The method of claim 14, further comprising exposing the vaporized material and the vaporized first thin film to the vacuum of the Moon.
